(19) United States
(12) Patent Application Publication
(10) Pub. No.: US 2004/0163261 A1
(43) Pub. Date: Aug. 26, 2004

(54) Knife having effectively changeable blades

(76) Inventor: Hsing Tai Lin, Taichung (TW)

Correspondence Address: Hsing Tai Lin, P.O.Box 63-99, Taichung, 406, TW

(21) Appl. No.: 10/373,551

(22) Filed: Feb. 21, 2003

(51) Int. Cl. B26B 3/06; F41B 13/02; F41C 27/18

(52) U.S. Cl. 30/162

(57) ABSTRACT

A utility knife includes a carrier slidably received in a housing and having one or more orifices, and a blade disposed between the carrier and the housing. A latch has one or more pins extended through the orifices of the carrier, to engage into the blade and to retain the blade to the carrier, and for allowing the blade to be moved relative to the housing by the carrier. A spring may bias the latch against the carrier, to engage the pins of the latch into the blade. A button may selectively disengage the pins of the latch from the blade, to allow the blade to be removed from the carrier and to be replaced with new blades.

### BACKGROUND OF THE INVENTION

1. Field of the Invention

The present invention relates to a knife, and more particularly to a utility knife having an improved configuration for allowing knife blades to be easily changed or replaced with the other ones.

2. Description of the Prior Art

Various kinds of typical utility knives have been developed and comprise one or more knife blades slidably received in a handle or a housing, and movable in and out of the housing with a slidable blade support or carrier. The carrier includes a configuration for allowing the knife blades to be changed or replaced with the other ones when the knife blades have been worn out or damaged.

One example of the typical utility knives has been disclosed in U.S. Pat. No. 3,577,637 to Braginetz, and comprises a carrier for supporting and for moving the knife blades in and out of the housing. The carrier includes an elastic and slotted section to resiliently support the knife blades. However, the elastic and slotted section of the carrier has a bottom portion solidly formed integral with the carrier and will be easily broken from the carrier after use.

The applicant has developed another typical utility knife which has been disclosed in U.S. Pat. No. 6,249,975 B1 to Lin, and which includes a carrier having an improved elastic and slotted section to resiliently support the knife blades. However, the elastic and slotted section of the carrier also includes one or more portions solidly formed integral with the carrier and will be easily broken from the carrier after use.

The present invention has arisen to mitigate and/or obviate the afore-described disadvantages of the conventional utility knives.

### SUMMARY OF THE INVENTION

The primary objective of the present invention is to provide a utility knife including an improved configuration for allowing knife blades to be easily changed or replaced with the other ones.

The other objective of the present invention is to provide a utility knife including a latch biased against a carrier by a spring member, to effectively retain one of the knife blades to the carrier.

In accordance with one aspect of the invention, there is provided a utility knife comprising a housing, a carrier slidably received in a guide channel of the housing, and including at least one orifice formed therein, at least one blade disposed between the carrier and the housing and including at least one notch formed therein, a latch including at least one pin extended through the orifice of the carrier, to engage into the notch of the blade and to retain the blade to the carrier, and for allowing the blade to be moved relative to the housing by the carrier with the pin of the latch. A spring biasing device may be provided for biasing the latch against the carrier, to engage the pin of the latch into the notch of the blade, and a disengaging device may be provided for disengaging the pin of the latch from the blade, to allow the blade to be removed from the carrier. The latch is a separate member from the carrier and is not formed integral with the carrier, and may thus be easily manufactured. In addition, the spring biasing device may solidly and effectively bias and force the latch against the carrier, in order to solidly secure the latch to the carrier/

The latch includes a groove formed therein. The carrier includes two pegs extended therefrom. The spring biasing device includes a spring member received in the groove of the latch, and engaged with the latch and having two ends secured to the pegs of the carrier.

One or more spare blades may further be provided and disposed between the blade and the housing. The housing includes a spring member provided therein and engaged with the spare blades, to bias and force the blades against the carrier.

The carrier includes a knob secured thereto and partially extended out of the housing for moving the carrier relative to the housing.

The disengaging device includes a button slidably engaged in the housing, and having at least one leg engageable with the latch, to selectively move the latch away from the carrier, and to selectively disengage the pin of the latch from the notch of the blade. The latch includes a fence extended therefrom, and extended beyond the carrier for engaging with the leg of the button. The latch includes a recess formed therein and defined by the fence, to receive the leg of the button.

Another spring biasing device may further be provided for biasing the button away from the housing, to disengage the leg of the button from the latch.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a utility knife in accordance with the present invention;

FIG. 2 is a perspective view of the utility knife;

FIG. 3 is a perspective view illustrating a slidable carrier of the utility knife;

FIG. 4 is a perspective view of the utility knife, in which one half of the handle or housing has been removed to show the configuration of the carrier; and

FIGS. 5 and 6 are perspective views illustrating the operation of the carrier of the utility knife.

### DETAILED DESCRIPTION OF THE PREFERRED EMBODIMENT

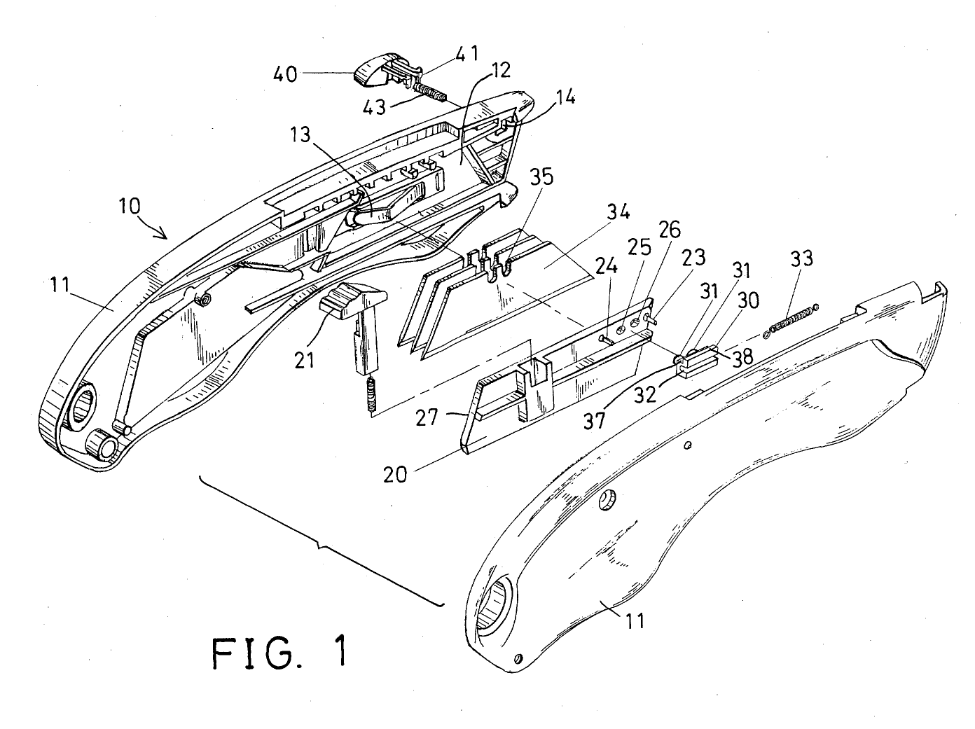

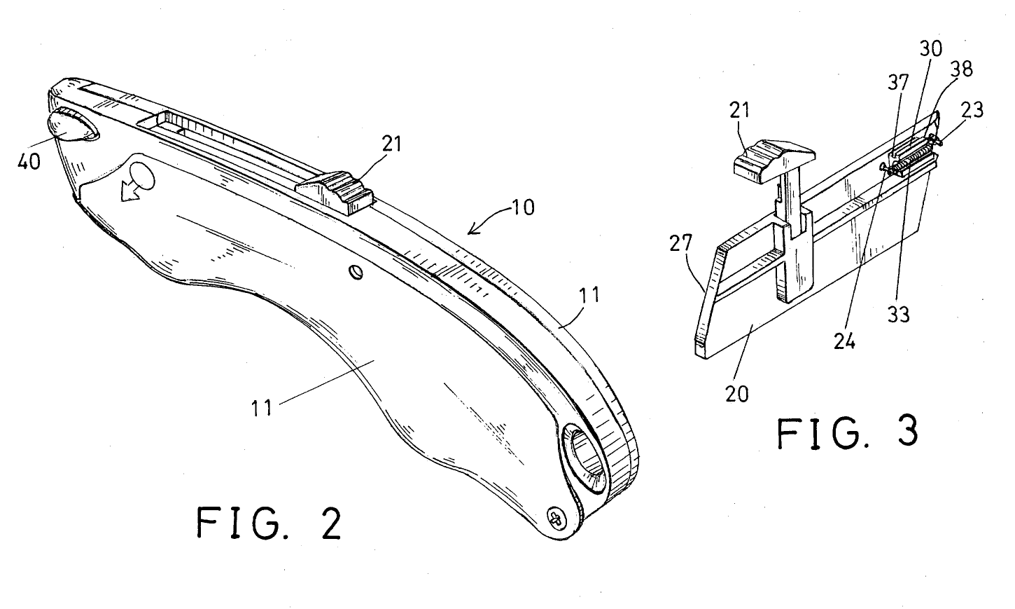

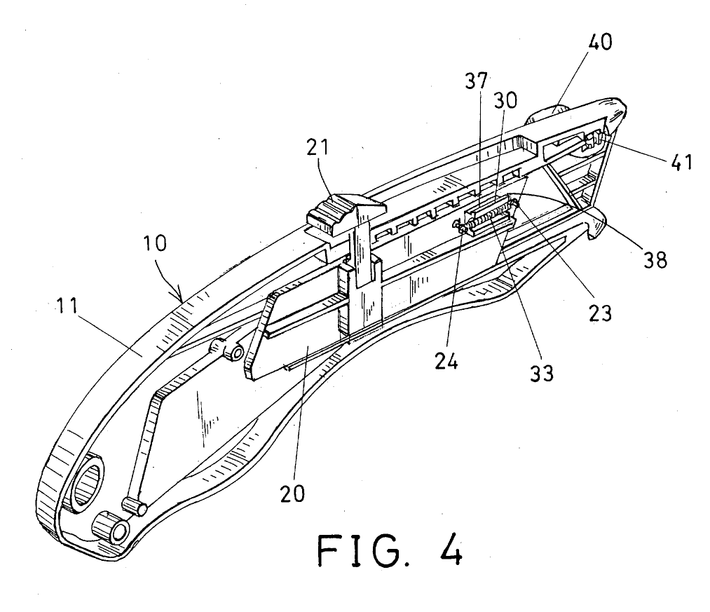

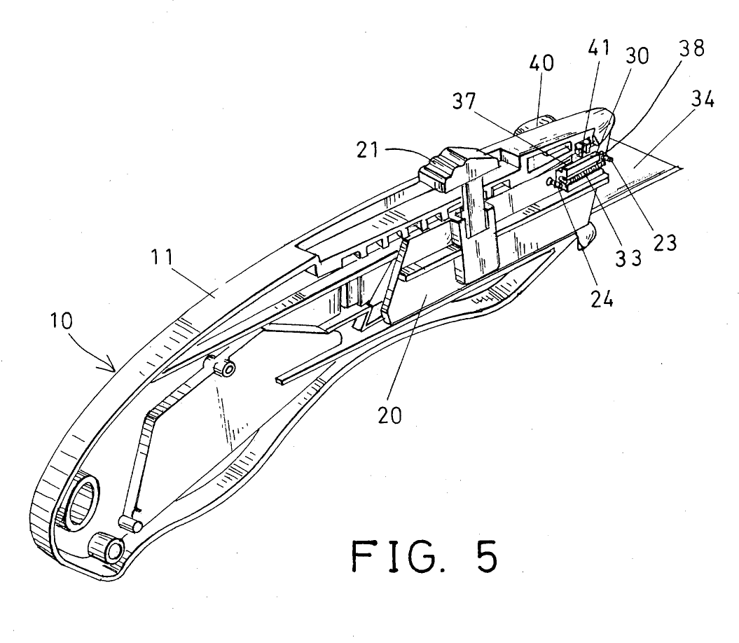

Referring to the drawings, and initially to FIGS. 1-4, a utility knife in accordance with the present invention comprises a handle or a housing 10 including such as two members 11 secured together with catches, latches, fasteners (not shown) or the like, and including a guide channel 12 formed therein. The housing 10 includes a spring biasing member, such as a spring member 13 provided therein and extended into the guide channel 12 thereof.

A carrier 20 is slidably received in the guide channel 12 of the housing 10, and includes a knob 21 secured to the carrier 20 and partially extended out of the housing 10, for allowing the carrier 20 to be moved along the guide channel 12 of the housing 10 and to be moved forwardly and rearwardly relative to the housing 10 by the knob 21. The carrier 20 includes one or more, such as two pegs 23, 24 extended therefrom, and one or more, such as two orifices 25, 26 formed therein, and preferably formed between the pegs 23, 24.

A latch 30 includes one or more, such as two pins 31 extended therefrom, and slidably received in the orifices 25, 26 of the carrier 20 respectively, and includes a groove 32 formed therein, preferably opposite to the pins 31 thereof. A spring member 33 is received in the groove 32 of the latch 30, and includes two ends secured to the pegs 23, 24 of the carrier 20, and is thus provided to bias the latch 30 against the carrier 20, and to force the pins 31 of the latch 30 out through the orifices 25, 26 of the carrier 20.

One or more knife blades 34 are disposed or attached to one side 27 of the carrier 20, opposite to the pegs 23, 24 and the latch 30, and disposed between the housing 10 and the carrier 20. Each of the blades 34 typically includes one or more, such as two notches 35 formed therein, for receiving the pins 31 of the latch 30 respectively, and for attaching one of the blades 34 to the carrier 20.

In addition, the spring member 13 of the housing 10 may engage with and may bias the blades 34 toward or against the carrier 20, for allowing the blades 34 to be solidly and effectively attached or secured or retained between the carrier 20 and the housing 10.

It is to be noted that the pins 31 of the latch 30 include a length to be engaged or extended out through the notches 35 of the blades 34, and to be extended beyond the carrier 20 for a length to engage into the notches 35 of only one of the blades 34, such that only the blade 34 located closest to the carrier 20 may be retained to the carrier 20 by the pins 31 and may be moved in and out of the housing 10 by the carrier 20. The other or spare blades 34 may still be retained in the housing 10 and between the carrier 20 and the spring member 13 of the housing 10.

It is further to be noted that the latch 30 is a separate member from the carrier 20, or is not formed integral with the carrier 20, and may thus be easily manufactured. In addition, the latch 30 may be solidly and effectively biased and forced against the carrier 20 and may thus be solidly secured to the carrier 20 by the spring member 33, in order to retain one of the blades 34 to the carrier 20.

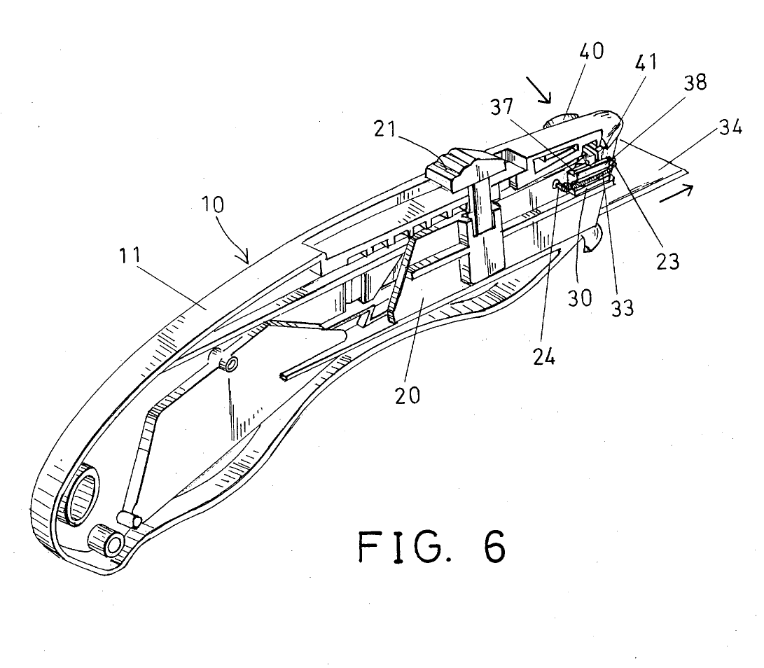

The latch 30 includes a recess 37 formed therein, preferably facing toward the carrier 20, and defined by an upwardly extended fence 38 that is upwardly extended beyond the carrier 20. The housing 10 includes a passage 14 formed therein, such as formed in the front portion thereof, and arranged slightly above the carrier 20. The recess 37 and the fence 38 of the latch 30 may be aligned with the passage 14 of the housing 10 when the latch 30 is moved toward the front portion of the housing 10 by the carrier 20 (FIGS. 5, 6).

A button 40 includes one or more, such as two hook-shaped legs 41 extended therefrom and slidably engaged through the passage 14 of the housing 10, and movable or extendible into the recess 37 of the latch 30, and engageable with the fence 38 of the latch 30 (FIGS. 5, 6). A spring 43 is engaged between the button 40 and the housing 10, for biasing the button 40 out of the passage 14 of the housing 10, and for disengaging the legs 41 of the button 40 from the recess 37 and the fence 38 of the latch 30.

In operation, the spring member 33 may solidly and effectively bias and force the latch 30 against the carrier 20, in order to solidly secure the latch 30 to the carrier 20, and so as to force the pins 31 of the latch 30 to engage into the notches 35 of the blade 34 that is located closest to the carrier 20. The blade 34 that is located closest to the carrier 20 may thus be solidly attached or secured to the carrier 20 with the pins 31, and may thus be moved relative to the housing 10 by the carrier 20.

When it is required to remove or to change the blade 34 that is located closest to the carrier 20 and that may be worn out or damaged, as shown in FIG. 6, the button 40 is depressed toward the housing 10 against the spring 43, to force the legs 41 of the button 40 to engage with the latch 30 or the fence 38, and to move the latch 30 away from the carrier 20 against the spring member 33, in order to disengage the pins 31 of the latch 30 from the blade 34 that is located closest to the carrier 20.

The button 40 and/or the legs 41 of the button 40 may thus be used as a disengaging device to disengage the pins 31 of the latch 30 from the blade 34 that is located closest to the carrier 20.

At this moment, the blade 34 that is located closest to the carrier 20 may thus be pulled out of the housing 10 by the users when the pins 31 of the latch 30 are disengaged from the blade 34 that is located closest to the carrier 20. The other or the next blade 34 may then be moved or biased against the carrier 20, and may have its notches 35 to receive the pins 31 of the latch 30, and may thus be moved in and out of the housing 10 by the carrier 20.

Accordingly, the utility knife in accordance with the present invention includes an improved configuration for allowing knife blades to be easily changed or replaced with the other ones, and includes a latch biased against a carrier by a spring member, to effectively retain one of the knife blades to the carrier.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A utility knife comprising:
a housing,
a carrier slidably received in said housing, and including at least one orifice formed therein,
at least one blade disposed between said carrier and said housing, and including at least one notch formed therein,
a latch including at least one pin extended through said at least one orifice of said carrier, to engage into said at least one notch of said at least one blade, and to retain said at least one blade to said carrier, and for allowing said at least one blade to be moved relative to said housing by said carrier with said at least one pin of said latch,
a first spring biasing means for biasing said latch against said carrier, to engage said at least one pin of said latch into said at least one notch of said at least one blade, and
means for disengaging said at least one pin of said latch from said at least one blade, to allow said at least one blade to be removed from said carrier.

2. The utility knife as claimed in claim 1, wherein said latch includes a groove formed therein, said first spring biasing means includes a spring member received in said groove of said latch.

3. The utility knife as claimed in claim 1, wherein said carrier includes two pegs extended therefrom, said first spring biasing means includes a spring member engaged with said latch and having two ends secured to said pegs of said carrier.

4. The utility knife as claimed in claim 1 further comprising at least one spare blade disposed between said at least one blade and said housing.

5. The utility knife as claimed in claim 4, wherein said housing includes a spring member provided therein and engaged with said at least one spare blade, to bias and force said at least one spare blade and said at least one blade against said carrier.

6. The utility knife as claimed in claim 1, wherein said carrier includes a knob secured thereto and partially extended out of said housing for moving said carrier relative to said housing.

7. The utility knife as claimed in claim 1, wherein said disengaging means includes a button slidably engaged in said housing, and having at least one leg engageable with said latch, to selectively move said latch away from said carrier, and to selectively disengage said at least one pin of said latch from said at least one notch of said at least one blade.

8. The utility knife as claimed in claim 7, wherein said latch includes a fence extended therefrom, and extended beyond said carrier for engaging with said at least one leg of said button.

9. The utility knife as claimed in claim 8, wherein said latch includes a recess formed therein and defined by said fence, to receive said at least one leg of said button.

10. The utility knife as claimed in claim 7 further comprising a second spring biasing means for biasing said button away from said housing, to disengage said at least one leg of said button from said latch.
